(19) United States
(12) Patent Application Publication
(10) Pub. No.: US 2026/0195560 A1
(43) Pub. Date: Jul. 9, 2026

(54) ENTITY RESOLUTION CHATBOT

(71) Applicant: Wells Fargo Bank, N.A., San Francisco, CA (US)

(72) Inventors: Niladri Bhattacharya, Livingston, NJ (US); Frank H. Dix, New York, NY (US); Michael Charles Reynolds, Avon, CT (US)

(21) Appl. No.: 19/009,719

(22) Filed: Jan. 3, 2025

(51) Int. Cl. G06N 3/006; G06N 3/0475; G06N 3/08

(52) U.S. Cl. CPC G06N 3/006; G06N 3/0475; G06N 3/08

(57) ABSTRACT

Systems and techniques may generally be used to assist a user of an entity resolution system. An example method may include receiving, at an entity resolution service and during a conversation between a chatbot and a user, a user query entered by the user. The method may include determining, using a generative artificial intelligence (GenAI) model, a context configured to be predictive of an intent of the user query and, based on the context, generating, using the GenAI model, a contextual query configured to generate a response to the intent of the user query. The method may include obtaining data responsive to the user query based on a search of an entity resolution data source using the contextual query, generating, using the GenAI model, a response to the intent of the user query based on the obtained data, and outputting the response to the chatbot service interface for display.

### BACKGROUND

Entity resolution is a process by which organizational entities (commercial businesses, corporations, and others) are identified so that they can be onboarded as clients. An organizational entity is required to submit proof of identity through forms and documentation, all of which must meet regulatory requirements and produce sufficient evidence of structure, activity, and ownership of the entity. Entity resolution is critical for accurate customer data management, regulatory compliance, detecting criminal activities (e.g., fraud, money laundering, or the like), and personalized services. Entity resolution problems are very complex, demanding time and a large and highly specialized team for handling exceptions. Traditionally, an entity resolution process uses an entity resolution team to manually examine a vast amount of data to ensure data accuracy and consistency across various data sources.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic of an example chatbot system, in accordance with some examples.

FIG. 2 illustrates an example Generative Artificial Intelligence (GenAI) system, in accordance with some examples.

FIGS. 3-4 illustrate example graphical user interfaces including message sequences between a user and a chatbot, in accordance with some examples.

FIG. 5 is a flowchart illustrating a technique for using a chatbot to assist users navigate an entity resolution process, in accordance with some examples.

FIG. 6 is a block diagram of a machine upon which any one or more of the techniques discussed herein may perform, in accordance with some examples.

### DETAILED DESCRIPTION

In various examples described herein, user interfaces are described as being presented on a computing device. Presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

The user interfaces are often described herein as having different portions or elements. Although, in some examples, these portions may be displayed on a screen at the same time, in other examples, the portions or elements may be displayed on separate screens such that not all of the portions or elements are displayed simultaneously. Unless explicitly indicated as such, the use of “presenting a user interface” does not infer either one of these options.

The systems and techniques described herein may be used to coach or assist a user of an entity resolution system. For example, a user may fail to resolve the identity of a particular entity, even after an extensive search, due to a lack of expertise (e.g., inexperience in searching databases, parsing documentation, applying policy and controls, managing workflow, inexperience in other areas in which the user may lack the knowledge to verify a given entity or the like). A user may struggle during a customer onboarding process of registering a new entity into the system or verifying legitimacy to prevent fraud. In an example, the customer onboarding process may include a know your customer (KYC) procedure, identity (ID) verification, personal document collection, or the like.

In order to provide assistance without the limitations of human coaching, a model may receive a user query, generate a contextual query, obtain data from a data source based on the contextual query, and provide a suggestion (e.g., how to proceed, where to find information, or the like) or a search result (e.g., a list of customers according to a contextual query, or the like) based on the obtained data. The entity resolution chatbot may generate an answer (e.g., a suggestion, a flag, a prompt, or the like). In an example, each generated answer by the entity resolution chatbot is tagged to a specific document, a portion of a document, a set of documents, a form, a process, a previous user query by a user (e.g., content of the user query, a way of sequencing the query, or the like), a previous user query by another user, a previous chatbot response (e.g., to the user, to another user, or the like), or the like. In an example, the entity resolution chatbot makes a suggestion about an ‘eyes-on’ opportunity for further evaluation, the chatbot points to a particular portion of a document and makes the suggestion based on chatbot previous learning.

The model may be an entity resolution chatbot supporting a user in performing one or more entity resolution tasks. The entity resolution chatbot may interact with the user based on information extracted from a document being examined and a user query from the user to perform an entity resolution task. The each entity resolution task of the one or more entity resolution tasks may be classified in one of four different categories: Document Analysis category, Search Optimization category, Workflow Management and Reporting category, and Smart Wizarding and Guidance category.

The one or more entity resolution chatbot tasks in the Document Analysis category may include suggesting a location of information (e.g., assisting in parsing legal and commercial documents to help a user find the information they need for a given review or investigation, or the like). The one or more entity resolution chatbot tasks in the Document Analysis category may include suggesting a model of a client activity, ownership structure or risk (e.g., assisting in parsing legal and commercial documents to build a model of ownership structure that may be edited and completed by the user, or the like). The one or more entity resolution chatbot tasks in the Document Analysis category may include suggesting an ‘eyes-on’ opportunity (e.g., generating alerts pointing to portions of a document that may suggest challenges to compliance or regulatory requirements, asking the user to examine those challenges, making suggestions to help the user remediate those challenges, or the like). The one or more entity resolution chatbot tasks in the Document Analysis category may include suggesting a remediation opportunity (e.g., the chatbot may do an overall assessment of the document, suggest adding information that the document is missing, both intrinsically (what is missing from the form or document) and extrinsically [given the information in this document, what is still missing from the compliance review], or the like).

The one or more entity resolution chatbot tasks in the Search Optimization category may include suggesting a query of a publicly available database, suggesting a query of a licensed database (e.g., integrated through an API), suggesting a query of an internal system (e.g., leveraging documentation associated with the internal system to prompt with an internal contact for follow-up in case a valid result is not found, or the like), or the like, to optimize the quality of a search result. The one or more entity resolution chatbot tasks in the Search Optimization category may include offering a search functionality using a comprehensive meta-search approach across multiple databases (public, licensed, internal) (e.g., outputting results with source tags that include deep links to the original search engine of the database, enabling users to continue exploring within that specific source database, or the like).

The one or more entity resolution chatbot tasks in the Workflow Management and Reporting category may include flagging a portion of the document for further investigation and escalation. The entity resolution chatbot may be integrated with a compliance system. The one or more entity resolution chatbot tasks in the Workflow Management and Reporting category may include activating an escalation protocol (e.g., a user may query the chatbot to escalate a question and route to an appropriate internal contact, the chatbot may be integrated with a secure and compliance internal messaging system, or the like). The one or more entity resolution chatbot tasks in the Workflow Management and Reporting category may include flagging a document, a portion of the document, a form, or the like, that is incomplete (e.g., information is missing). The one or more entity resolution chatbot tasks in the Workflow Management and Reporting category may include suggesting an internal contact for further coordination and investigation of a particular entity. The one or more entity resolution chatbot tasks in the Workflow Management and Reporting category may include preparing a report of all chatbot-assisted activity.

The one or more entity resolution chatbot tasks in the Smart Wizarding and Guidance category may include providing a definition or explanation of a regulation, a control, a policy, a form type, providing an element of compliance, or the like, based on a user natural language request. The one or more entity resolution chatbot tasks in the Smart Wizarding and Guidance category may include suggesting an alternative investigative approach (e.g., based on what the user already tried, on what the chatbot has learned through supporting other users, or the like, the chatbot will suggest an alternative approach to identify and verify an entity). The one or more entity resolution chatbot tasks in the Smart Wizarding and Guidance category may include sequencing all prompts and suggestions based on an optimal protocol for entity resolution (e.g., given the particular challenges of the entity verification task, the most efficient protocol for resolving the identity of an entity may be by searching a database, looking for an additional document, and consulting with another internal group, all in a particular order). The chatbot may direct an entity verification based on accumulated experience (e.g., learning). The one or more entity resolution chatbot tasks in the Smart Wizarding and Guidance category may include offering specialized guidance for a family entity resolution. For example, when an entity is part of a larger ownership structure, specialized documentation or a specialized procedure may apply. The entity resolution chatbot may support a user in evaluating the specialized documentation or guide the user through the specialized procedure.

The model may utilize a deep learning technique to execute one or more language processing tasks utilizing one or more machine-learned models (e.g., large language model (LLM)). The contextual query may include data search instructions (e.g., find companies on SEC official records, find companies that are allowed to offer shares for sale, find data related to a new customer, or the like) for generating the response to the user query.

Features of the user query may be used as input to the model. Features of the user query may include content of the query, content of a previous query, information about the entity being searched, content from user feedback from a previous interaction, a user level of expertise classification, content from a document (e.g., a document being examined by the user, a portion of a document, a set of documents, or the like) or the like.

Different users may need different assistance. A one-size-fits-all model that detects all possible assistance to provide may be undesirable as it may present suggestions that are unhelpful to a user dealing with a specific problem or with a determined level of knowledge. Having the application provide all possible suggestions may overwhelm the user. Each user may have a user level of expertise classification in the server. The systems and techniques described herein may present different kinds of assistance based on the user level of expertise classification. In an example, each user level of expertise classification deals with specific kinds of pitfalls related to the entity resolution process.

Entity resolution may include an entity resolution task in the Search Optimization category of parsing data from one or more different sources (e.g., own database, third party database, cloud database, streams of data, or the like) to identify data related to an entity, consolidating the identified data, associating the consolidated data to the entity, or identifying a relationship (e.g., derived relationship, disclosed relationship, or the like) between the entity and one or more other entities. Consolidating data may include deleting duplicated records. The data related to the entity may include customer information, transaction data, application usage data, customer relationship management (CRM) data, or the like.

In an example, a stream of data (e.g., usage data of a website, an application, or a server, interaction data of a customer with a business, or the like) may be retrieved from one or more sources, such as one or more websites, applications, or servers that are configured to track the behavior of the entity. For example, a source may include a website to which one or more code snippets have been added to load analytics, identify users, or track the actions of the users.

An entity is a real-world object with a distinct and independent existence from other things. Each entity is described by its distinguishing characteristics (sometimes called attributes) that make it unique. The values of those attributes may be used to identify a specific entity. The entity may be a place, a business, an organization, a product, an event, an account, an order, a user, a customer, a household, or the like. In an example, the attributes of an entity may include a name, a social security number (SSN), an employer identification number (EIN), an address (e.g., home address, work address, or the like), e-mail address (e.g., personal e-mail, work e-mail, or the like), phone number, date of birth, a fingerprint, or the like. In another example, the attributes of a product may include a serial number, a model number (or name), a manufacturer, an origin, a universal product code (UPC), or the like. The entity may have different records including different values for the same attribute (e.g., an entity may have records with different name values, such as William, Will, Bill, or the like). The systems and techniques described herein may identify that the different records belong to a same entity and associate the data in those records to the entity.

In an example, each of the attributes of the entity may be represented as an identifier (e.g., a profile identifier, a unique identifier, an ID to an external system, or the like). In an example, identity resolution is a type of entity resolution where the targeted entity is an individual (e.g., a customer, a user, an organization, or the like). Identity resolution may support the Know Your Customer (KYC) process by consolidating information accurately of each customer.

The systems and techniques described herein may include receiving a user query about an entity (e.g., a customer) from a user in a chatbot session and, in response to the user query, filtering information about the entity using data behind the entity extracted from a data source (e.g., own database, third party database, cloud database, or the like).

In an example, the systems and techniques described herein include using a chatbot to respond to a user query about the targeted entity and using a generative artificial intelligence (GenAI) model (e.g., a large language model (LLM), or the like) to make the chatbot search more capable of converting plain English input (e.g., via text, voice, video, or the like) to a contextualized query (e.g., the chatbot may convert “is this company registered?” to “search whether the name of the company is on the official records of the Securities and Exchange Commission and whether the company is allowed to offer shares for sale”). A chatbot search (e.g., input of the chatbot search, output of the chatbot search, feedback from a user of the chatbot service, or the like) may be used to retrain the machine-learning model. In this way, the chatbot may continuously improve the ability to contextualize queries and the quality of its responses.

In an example, the chatbot responses may be scored with a reliability score based on a GenAI model that may be trained using labeled training data (e.g., a set of examples of responses paired with the corresponding query and score, or the like), feedback data (e.g., the GenAI model may receive feedback based on their scoring accuracy and improve over time), or the like. The GenAI model may be updated using further input data until a satisfactory model is generated. The GenAI model may be refined through user interaction (e.g., refining queries, providing additional forms and documents, searching other databases, examining different portions of the same documents, or the like). By being refined, the model learns and develops more efficient approaches to getting to the right information for the right entity resolution task. The model may learn (e.g., retrain, update, modify, or the like) with the previous output of the model. The chatbot responses with reliability scores below a threshold may be forwarded to an agent (e.g., a system manager, a more experienced user, or the like). The agent may respond by using the chatbot response or another response. The GenAI model may be retrained using the query and response sent to the user (e.g., the chatbot response or the response by the agent).

The systems and techniques described herein may include guiding a user, using the chatbot, to the right resource at the right time for the right type of onboarding request. This guidance may optimize entity resolution for onboarding a client, onboarding a product for an existing client, exiting a client or a product, or another task involving entity resolution and verification.

Entity resolution systems tend to slow down as they are loaded with more data. The systems and techniques described herein improve the performance of entity resolution systems by determining a context and generating a contextual query, which results in dealing with a smaller amount of data that is appropriated for the right purposes at the right time.

Entity resolution systems may present false positive results. The systems and techniques described herein improve the accuracy of entity resolution systems by using a chatbot for entity resolution, which decreases the odds of falsely associating data to the entity and having to go through a large exception process to manage false data.

People working with entity resolution systems may not have the specialized knowledge to locate the correct information (e.g., a person may not know what a registered or publicly traded company means, or the like). The systems and techniques described herein democratize advanced search by allowing the user of the entity resolution system to use plain language for the search (e.g., the entity resolution chatbot may assist a user through an entity resolution task in the Smart Wizarding and Guidance category, or the like).

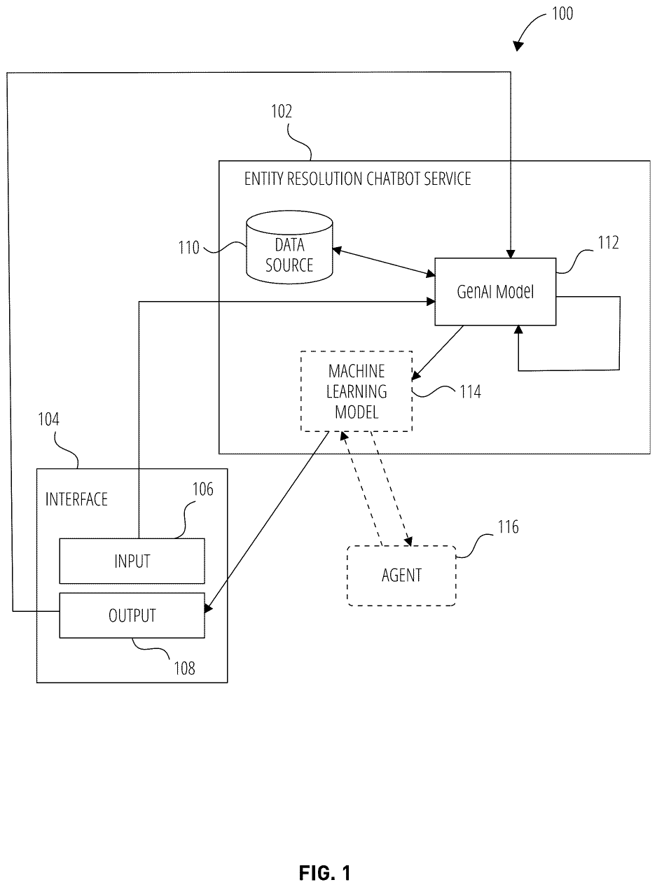

FIG. 1 is a diagram illustrating an entity resolution system 100, according to some examples. The entity resolution system 100 may include an interface 104, an entity resolution chatbot service 102, and an optional agent 116.

Input and Output interface 104 (e.g., a Graphical User Interface (GUI) on a webpage, on an application user interface, or the like) receives user queries (e.g., text messages, audio recordings, videos, or the like) at input 106 and forwards them to the entity resolution chatbot service 102. The entity resolution chatbot service 102 may use a GenAI model 112 and a data source 110 (e.g., a local database, a cloud data store, a third party database, or the like) to determine a context configured to be predictive of an intent of a user query from a user of the entity resolution system 100. The context may include a word, a phrase, or bits of information within the query that can be used by the entity resolution chatbot service 102 to predict an intent of the user query. The context may correspond to attribute values in the user query, such as a word indicating a temporal reference, a geographical location, a sequence of events (e.g., first, second, or the like), a phrase including a definition, a phrase indicating cause and effect, a textual pattern, a semantic relationship between two or more words or phrase (e.g., a synonym, an antonym, a type or genre, or the like), situational context (e.g., tone, intent, subject matter, or the like), historical context, or the like.

The entity resolution chatbot service 102 may generate, using the GenAI model 112, a contextual query based on the determined context. The GenAI model 112 may be trained using chatbot service historical data. The entity resolution chatbot service 102 may obtain data responsive to the user query based on a search of a data source 110 using the contextual query. The entity resolution chatbot service 102 may generate, using the GenAI model 112, a chatbot response to the intent of the user query based on the obtained data. The response may include an action suggestion (e.g., an action suggestion indicating where to find the information related to the intent of the user query, or the like), a list of customers as requested, information of a customer as requested, or the like. In an example, the chatbot service 102 outputs the response to the chatbot service interface 104 for display at output 108.

The entity resolution chatbot service 102 may determine whether there were keywords or key phrases detected in the user query (e.g., “this is not what I am looking for!”) indicating that the customer is experiencing frustration, or the like. Based upon one or more of these indicators (e.g., detected keywords, key phrases, or the like) and, in some examples, the chat history of the user, the entity resolution chatbot service 102 determines, using the GenAI model 112 trained using appropriate responses for a training set of questions, whether or not the response is to be forwarded to an agent 116 (e.g., a system manager, a more experienced user, or the like).

The entity resolution chatbot service 102 may calculate, using a machine learning model 114 trained using appropriate responses for a training set of questions, a reliability score for the response. The machine learning model 114 may be the same as the GenAI model 112 in some examples. The GenAI model 112 may be a large language model (LLM) or be part of an LLM. The chatbot service 102 may use a separate machine learning model 114 for scoring (e.g., determining a reliability score) the responses generated using the GenAI model 112. In an example, the machine learning model 114 is the same as GenAI model 112 and is used to score the responses generated using the GenAI model 112 based on certain criteria (e.g., relevance, clarity, coherence, completeness, engagement, user feedback, or the like). The machine learning model 114 may be selected from among many different potential supervised or unsupervised algorithms. The machine learning model 114 may be a Bidirectional Encoder Representations from Transformers (BERT) model, Sentence-BERT, Text-to-Text Transfer Transformer (T5), Generative Pre-trained Transformer (GPT), Long Short-Term Memory (LSTM) and Gated Recurrent Unit (GRU), Convolutional Neural Networks (CNNs), Recurrent Neural Networks (RNNs), Transformers with Attention Mechanisms, Support Vector Machines (SVM), or the like.

The entity resolution chatbot service 102 may be unable to generate a response, unable to interpret the user query, the reliability score of the response may be below a threshold, or the like. In those situations, the entity resolution chatbot service 102 may forward the user query, the contextual query, or the response to the agent 116 (e.g., a system manager, a system supervisor, a more experienced user, or the like).

The agent 116 may be a user of a group of more experienced users, a supervisor of users of the entity resolution system 100, or the like. The agent 116 may interpret the query and respond appropriately by either using the chatbot response or another response. In an example, the agent 116 forwards a second response (e.g., the chatbot response, another response created by the agent, or the like). The agent 116 may be a plurality of users of the entity resolution system 100. In this example, each response of each agent of the plurality of agents may receive a reliability score. The forwarded second response may include the response with the highest reliability score among the responses from the plurality of agents.

The second response by the agent 116 may replace the chatbot response before outputting the response to an output 108 at the chatbot service interface 104. The GenAI model 112 may be retrained using the user query and the second response by the agent 116. In an example, outputting the response to the chatbot service interface 104 for display at output 108 includes outputting the response to the chatbot service interface 104 for display at output 108 in response to the chatbot response being scored above the threshold. In an example, the response scored above the threshold is used to retrain the GenAI model 112.

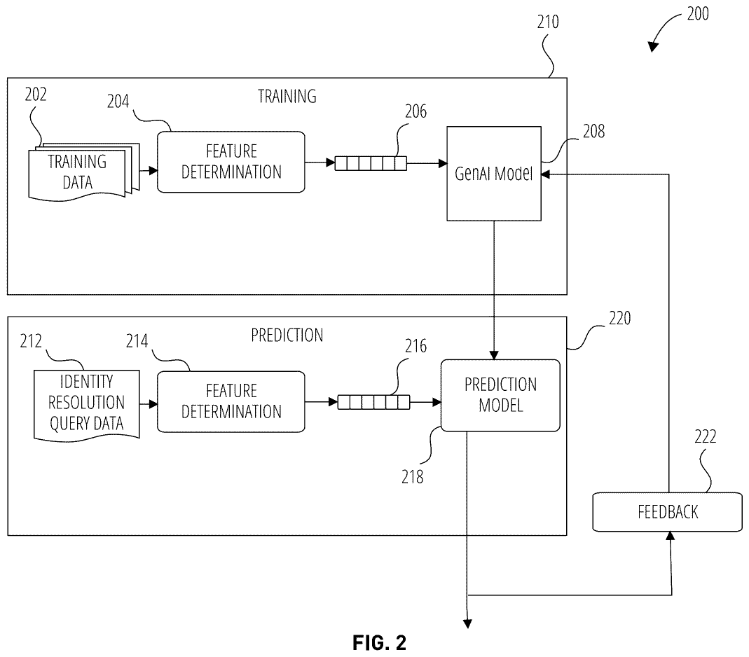

FIG. 2 illustrates an example Generative Artificial Intelligence (GenAI) system 200 (e.g., 112, or the like) for an entity resolution system, according to an example. The GenAI system 200 may be a Large Language Model (LLM) or may be part of an LLM. Large Language Models (LLMs) are a type of deep learning model specifically designed for processing and generating human-like text. LLMs are used in conversational AI, automated content generation, advanced language translation, and code generation tools.

The GenAI system 200 utilizes a training component 210, and a prediction component 220. Training component 210 feeds training data 202 into feature determination component 204 which determines one or more features 206 from this information. In an example, the training data 202 includes data from previous identity resolution interactions between users and a chatbot of the entity resolution system. The training data 202 may include a set of examples of user queries and a corresponding set of example responses labeled with labels or tags (e.g., “appropriate response,” “inappropriate response,” or the like). The set of example responses may be labeled based on clarity, coherence, accuracy, or the like. The training data may include an unlabeled set of sample responses paired with corresponding queries. The feature determination component 204 may determine features 206 (e.g., patterns and structure) of the unlabeled data. The training data 202 may include user feedback from previous interactions (e.g., feedback from all users of the entity resolution system, feedback from a group of users, feedback from a single user, or the like).

The feature determination component 204 may extract one or more features 206 from the training data by at least one of the techniques of tokenization (e.g., splitting text into smaller units (tokens), such as words or sentences), N-grams (e.g., sequences of ‘n’ words or characters from the text), Named Entity Recognition (NER) (e.g., identifying named entities in text), Term Frequency (e.g., counting how often a word appears in a text), Word Embedding (e.g., vector representation of words that capture semantic meanings and relationships), Sentiment Analysis Features (e.g., extracting sentiment related features, such as emotion classification), or the like.

The Generative Artificial Intelligence (GenAI) model 208 produces a prediction model 218 based on the extracted features 206 and feedback 222. The prediction model 218 may be for the entire system (e.g., built of training data accumulated throughout the entire system, regardless of the user for which optimal usage data is being calculated) or may be built specifically for a user or a user group. In an example, the user group includes one or more users having a same user level of expertise classification.

In the prediction component 220, the current identity resolution query data 212 (e.g., data of the query entered by the currently logged user, suggested action to the query, contextual query, user level of expertise classification of the currently logged user, or the like) may be input to the feature determination component 214. Feature determination component 214 may determine the same set of features or a different set of features as feature determination component 204. In some examples, feature determination component 214 and feature determination component 204 are the same component. Feature determination component 214 produces features 216, which are input into the prediction model 218.

The prediction model 218 may be periodically updated via additional training or feedback 222. The prediction model 218 may output a response (e.g., an action suggestion, a requested information, an ordered sequence to the user query, or the like) to the intent of the user query based on the features 216. The feedback 222 may include feedback from users of the identity resolution system (e.g., responses to questions about accuracy of results, or the like) or may be automated feedback (e.g., if the user does not select the suggested action, or the like).

The GenAI model 208 may be selected from among many different potential supervised or unsupervised algorithms. The GenAI model 208 may include Generative Adversarial Networks (GANs), Variational Autoencoders (VAEs), Transformers, Recurrent Neural Networks (RNNs), Diffusion Models, Sequence-to-Sequence Models, Attention Mechanisms, Autoregressive Models, Flow-based Models, Conditional Generative Models, or the like.

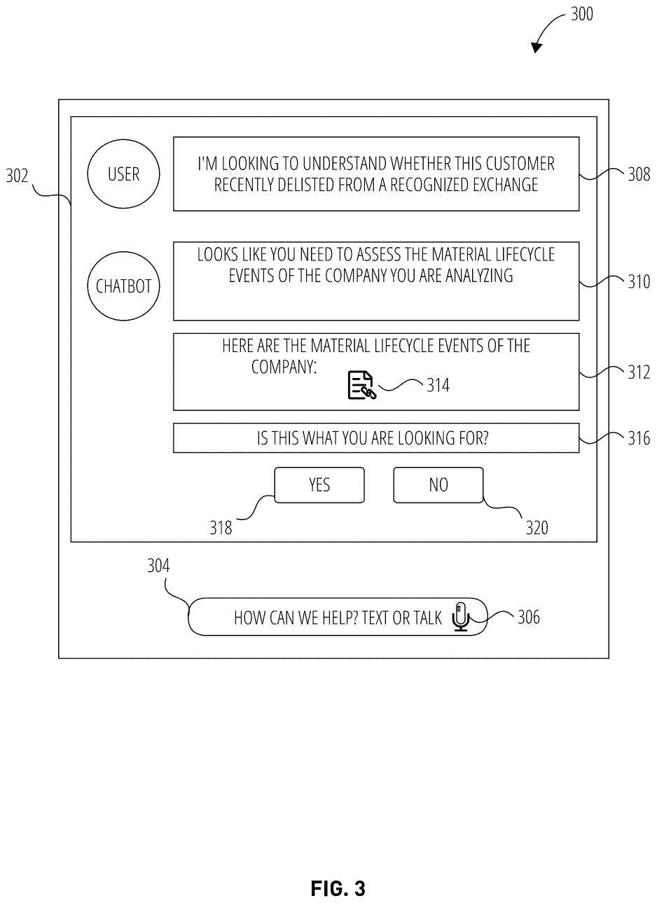

FIG. 3 illustrates a graphical user interface (GUI) 300 displayed for a user logged into an entity resolution system (e.g., entity resolution system 100, or the like), according to some examples. The GUI 300 includes various user interface components, such as an input component 304 having a voice recording button 306, and an output component 302. The position of the various user interface components displayed on GUI 300 may vary.

The entity resolution system analyzes a user query sent by the user (e.g., block 308, or the like) to determine a context configured to be predictive of an intent of the user query. The the entity resolution chatbot service may generate, using a GenAI model, a contextual query (e.g., 310, or the like) based on the context.

Block 308 shows a user query (e.g., a text message, an uploaded document, an uploaded form, or the like) sent to the chatbot of the entity resolution system using the input component 304, according to some examples. In an example, the user starts by typing a message in plain English (e.g., “I'm looking to understand whether this customer recently delisted from a recognized exchange.”). The entity resolution chatbot service analyzes the message, in block 308, determines a context, generates a contextual query (e.g., a query related to the intent of the user query), and outputs it on block 310 (e.g., “looks like you need to assess the material lifecycle events of the company you are analyzing.”). In another example, the user starts by uploading a document, by uploading a form, or the like. In that case, the entity resolution chatbot may analyze the document, the form, or the like, to generate the contextual query.

In an example, the user may request specific information to be parsed from the available databases (e.g., local database, third party database, cloud database, or the like). The chatbot may output the information requested or guide the user to a method for obtaining the requested information (e.g., 314) on block 312.

The chatbot service may collect explicit or implicit feedback from the user and use the feedback to retrain a GenAI model. In an example, the user may be presented with one or more controls, such as buttons 318 and 320 to provide feedback on whether the information provided is accurate (e.g., using the controls to respond to question 316). A link may be provided to receive feedback from the user. For example, the user may indicate whether the information provided is related (or unrelated) to the user query. In an example, the chatbot service may collect implicit feedback when the user selects an action suggestion. The implicit feedback may be used to retrain the GenAI model (e.g., the features (e.g., the user query, context, contextual query, obtained customer information, outputted response, or the like) used to derive the action suggestion may be labeled as being correctly contextualized and producing an appropriate action suggestion, or the like). In an example, if the user does not select the suggested action, the features used to derive that action suggestion may be saved as training data labeled as not being correctly contextualized or as producing an improper action suggestion.

The chatbot service may differentiate between whether the obtained written text was not correctly contextualized or whether the action recommendation was not appropriate (e.g., the text was correctly contextualized, but the suggestion was not helpful) through the user feedback. For example, if the user declines the action suggestion, the system may prompt the user as to why.

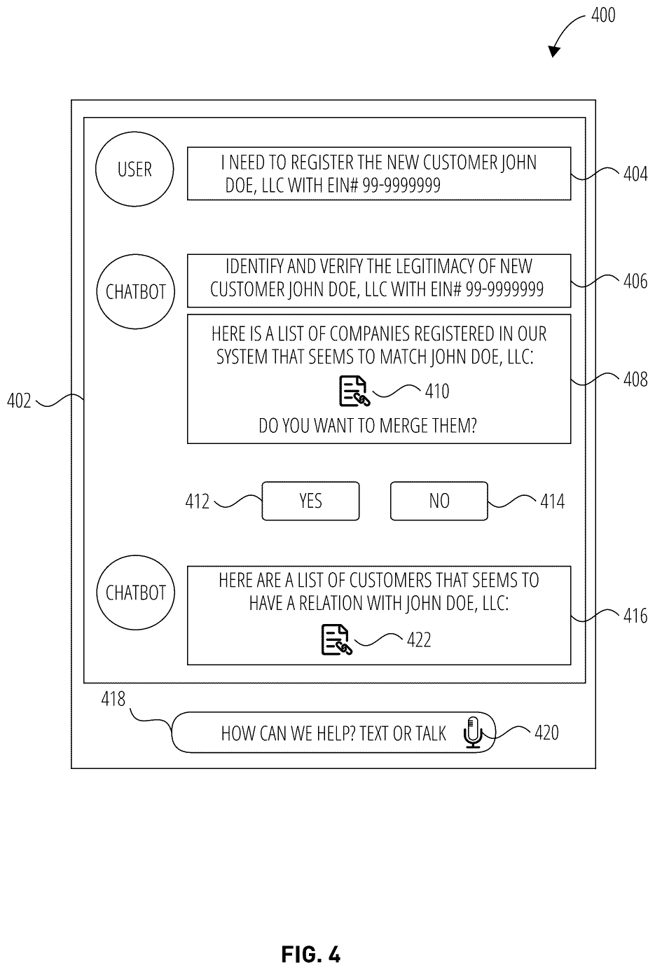

FIG. 4 illustrates a graphical user interface (GUI) 400 displayed for a user of an entity resolution system (e.g., entity resolution system 100, or the like), according to some examples. The GUI 400 includes various user interface components, such as an input component 418 having a voice recording button 420, and an output component 402. The position of the various user interface components displayed on GUI 400 may vary.

The entity resolution system analyzes the user queries sent by the user (e.g., 404, or the like) to determine a context configured to be predictive of an intent of the user query. The entity resolution system may generate, using a GenAI model, a contextual query (e.g., 406, or the like).

Block 404 shows an example of a user query (e.g., text message, voice recording, uploaded document, uploaded form, or the like) sent to the chatbot of the entity resolution system using the input component 418. In an example, the user enters a message in plain English (e.g., “I need to register the new customer john doe, LLC with EIN #99-9999999.”). The entity resolution system analyzes the user query in block 404, determines a context, generates a contextual query based on the context, and outputs the contextual query on block 406 (e.g., “to register a new customer you need to identify and verify its legitimacy.”). In an example, the user may request to execute an action (e.g., to register a new client, or the like). The chatbot may output, on block 408, information collected (e.g., 410, 422), an action suggestion based on its findings (e.g., “Do you want to merge them?”), or the like.

The chatbot service may collect feedback from the user and use it to retrain a GenAI model (e.g., the GenAI model shown in FIG. 2). In an example, the user may be presented with one or more controls, such as buttons 412 and 414 for accepting or declining the action suggestion provided by the chatbot service (e.g., “Do you want to merge them?” shown in 408). A link may be provided to receive feedback from the user. For example, to indicate that the action provided is not helpful.

In an example, the user may send a user query to the chatbot requesting information about a customer or requesting to register a client (e.g., 404). The chatbot service may collect all available data on the customer and identify relationships (e.g., derived relationship, disclosed relationship, or the like) with other entities (e.g., spouse, CEO, owner, or the like) based on the collected data. In block 416, for example, the chatbot displays a list of relationships 422 related to the customer in the user query (e.g., John Doe, LLC).

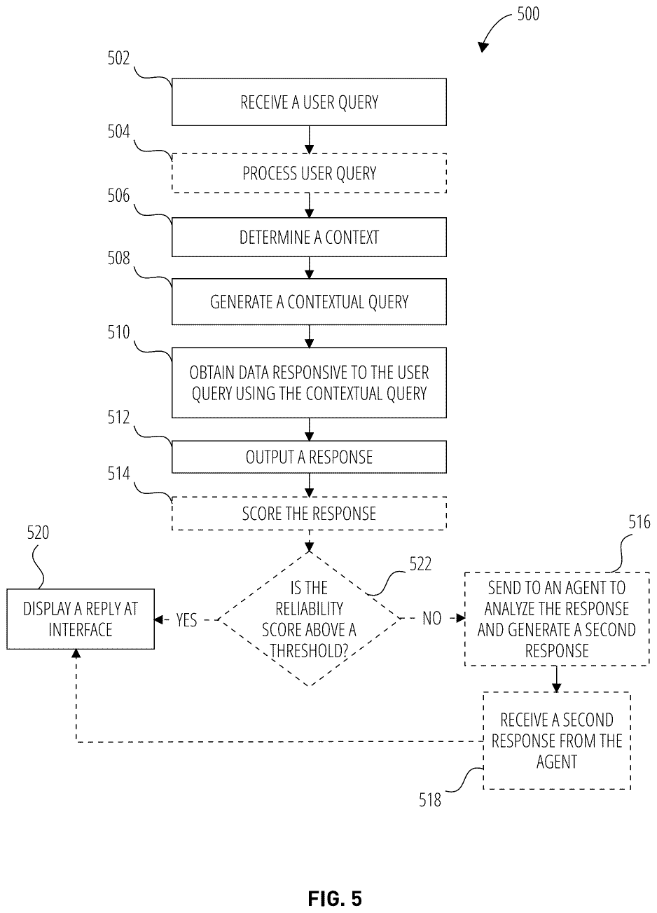

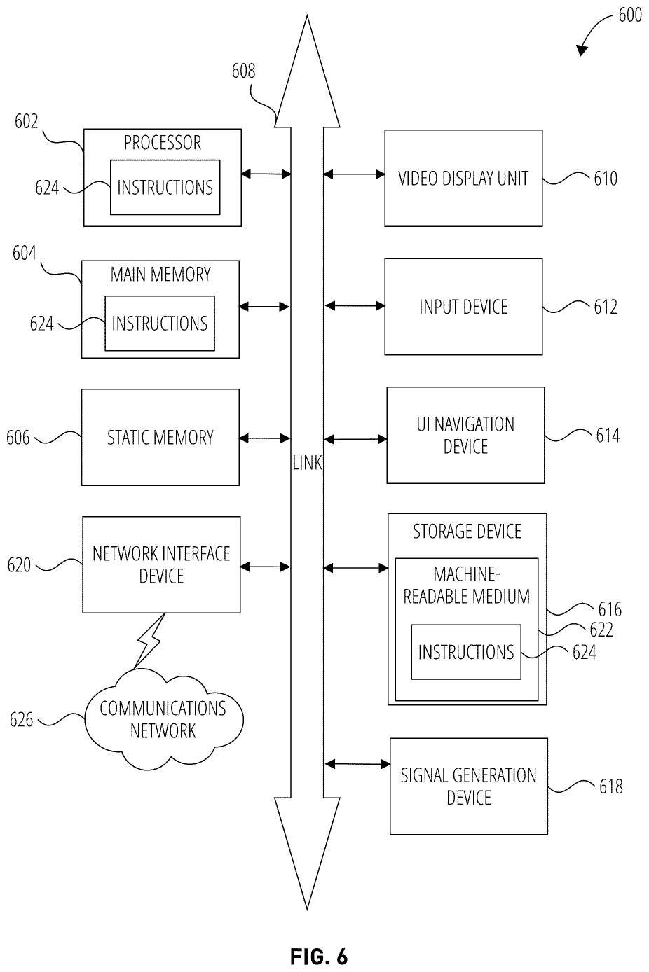

FIG. 5 illustrates a flowchart of a technique 500 for providing assistance to a user to navigate the entity resolution process, according to some examples. In an example, operations of the technique 500 may be performed by processing circuitry, for example, by executing instructions stored in memory. The processing circuitry may include a processor, a system chip, or other circuitry (e.g., wiring). For example, the technique 500 may be performed by processing circuitry of a device (or one or more hardware or software components thereof), such as those illustrated and described with reference to FIG. 6.

The technique 500 includes an operation 502 to receive (e.g., obtain, retrieve, capture, or the like), from an entity resolution service and during a conversation between a chatbot and a user logged into the entity resolution service on a chatbot service interface of the entity resolution service, a user query entered by the user. The user query may include at least one of a voice message or a video. In an example, the technique 500 includes an optional operation 504 to process the user query, wherein processing the user query includes converting the user query to written text. In operation 504, the technique 500 may utilize one or more methods, such as Hidden Markov Models, Dynamic Time Warping (DTW), neural networks, and the like.

In operation 506, technique 500 determines, using a GenAI model (e.g., large language model (LLM), a part of an LLM, or the like), a context configured to be predictive of an intent of the user query. The context may include a word, a phrase, or information within the user query related to the intent of the user query. The GenAI model may be trained with training data including historical data of an entity resolution chatbot service (e.g., previous text entries or outputs of the chatbot service 102, or the like).

In operation 508, technique 500 generates, using the GenAI model, a contextual query based on the context. In an example, the contextual query is configured to generate a response to the intent of the user query.

In operation 510, technique 500 obtains data responsive to the user query based on a search of an entity resolution data source using the contextual query. The obtained data may include information about a customer (e.g., account information, demographic information, social networking information, or the like). The data source may include a local database, a third-party database, a cloud database, a streaming data source, or the like.

In operation 512, technique 500 outputs, using the GenAI model, a response to the user query based on the obtained data. The response may include at least one of an action suggestion or a requested information. In operation 512, technique 500 may determine a particular pitfall in the information about the customer (e.g., multiple divergent profiles for a single customer, or the like) and may provide one or more suggestive corrective actions (e.g., pursue an additional research route through a new prompt and a new query, escalate to other team member specialized in customer due diligence, or the like) based on the detected pitfall. In an example, the user has a user level of expertise classification and the response is further based on the user level of expertise classification of the user.

In operation 514, technique 500 may determine, using a second trained machine learning model, a reliability score for the response. In some examples, in operation 522, technique 500 determines whether the reliability score is above a threshold. In operation 520, technique 500 may, in response to determining that the reliability score is above the threshold, output a reply including the response to the entity resolution chatbot service interface for display.

In operation 522, the technique 500 may determine whether the response has the reliability score below a threshold. In response to the determining that the response has a reliability score below the threshold, in operation 516, technique 500 may forward the response and the user query to an agent.

In some examples, in operation 518, technique 500 may receive a second response from the agent. In operation 520, in response to the receiving, technique 500 may output a reply including the second response to the entity resolution chatbot service interface for display. In an example, the agent includes a plurality of individuals, and the second response is a response with a highest score among responses of each individual of the plurality of individuals.

FIG. 6 is a block diagram illustrating a machine in the example form of computer system 600, within which a set or sequence of instructions may be executed to cause the machine to perform any one of the methodologies discussed herein, according to an example. In alternative examples, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, or the like), a main memory 604, and a static memory 606, which communicate with each other via a link 608. The computer system 600 may further include a video display unit 610, an input device 612 (e.g., a keyboard), and a user interface UI navigation device 614 (e.g., a mouse). In one example, the video display unit 610, input device 612, and UI navigation device 614 are incorporated into a single device housing such as a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensors.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, the static memory 606, and/or within the processor 602 during execution thereof by the computer system 600, with the main memory 604, the static memory 606, and the processor 602 also constituting machine-readable media.

While the machine-readable medium 622 is illustrated in an example to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 622 that excluded transitory signals.

The instructions 624 may further be transmitted or received over a communications network 626 using a transmission medium via the network interface device 620 utilizing any one of a number of well-known transfer protocols (e.g., HTTP). Examples of communication networks include a Local Area Network (LAN), a Wide Area Network (WAN), the Internet, mobile telephone networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Each of these non-limiting examples may stand on its own, or may be combined in various permutations or combinations with one or more of the other examples.

Example 1 is a method comprising: receiving, at an entity resolution service and during a conversation between a chatbot and a user logged into the entity resolution service on a chatbot service interface of the entity resolution service, a user query entered by the user; determining, using a generative artificial intelligence (GenAI) model trained with chatbot service historical data, a context configured to be predictive of an intent of the user query; based on the context, generating, using the GenAI model, a contextual query configured to generate a response to the intent of the user query; obtaining data responsive to the user query based on a search of an entity resolution data source using the contextual query; generating, using the GenAI model, a response to the intent of the user query based on the obtained data; and outputting the response to the chatbot service interface for display.

In Example 2, the subject matter of Example 1 includes, wherein the user query includes at least one of a document, a form, a text message, a voice message, or a video message.

In Example 3, the subject matter of Examples 1-2 includes, wherein determining the context includes identifying an attribute value in the user query, the attribute value including at least one of a temporal reference, a geographical location, a sequence of events, a definition, a cause and effect, a textual pattern, a semantic relationship, or a situational context.

In Example 4, the subject matter of Examples 1-3 includes, wherein the contextual query includes data search instructions for generating a response to the user query.

In Example 5, the subject matter of Examples 1-4 includes, collecting feedback from the user at the chatbot service interface; and retraining the GenAI model using the collected feedback.

In Example 6, the subject matter of Examples 1-5 includes, wherein the response includes at least one of an action suggestion, a reply including requested information, a flag suggesting further investigation, a report of all chatbot activity, an explanation, or a suggestion for an alternative approach.

In Example 7, the subject matter of Examples 1-6 includes, wherein the entity resolution data source includes at least one of a third-party database, a local database, a cloud data storage, or a streaming data source.

In Example 8, the subject matter of Examples 1-7 includes, wherein the user query is at least one of a voice message or a video message.

In Example 9, the subject matter of Example 8 includes, before determining the context of the user query, converting the user query to written text.

In Example 10, the subject matter of Examples 1-9 includes, wherein the user has a user level of expertise classification and the response is further based on the user level of expertise classification of the user.

In Example 11, the subject matter of Examples 1-10 includes, determining, using a machine learning model separate from the GenAI model, a reliability score for the response based on the user query; and determining whether the reliability score is above a threshold; wherein outputting the response to the chatbot service interface for display includes outputting the response to the chatbot service interface for display in response to determining that the reliability score is above a threshold.

In Example 12, the subject matter of Examples 1 -11 includes, determining, using using a machine learning model separate from the GenAI model, a reliability score for the response based on the user query; determining whether the reliability score is below a threshold; in response to the determining that the reliability score is below a threshold, forwarding the user query and the response to an agent; receiving a second response from the agent; and before outputting the response to the chatbot service interface for display, replacing the response with the second response.

In Example 13, the subject matter of Example 12 includes, wherein the agent includes a plurality of individuals, each individual generating an agent response; and further comprising: determining, using the machine learning model separate from the GenAI model, a score for each agent response of each individual of the plurality of individuals, wherein the second response includes an agent response with a highest score.

In Example 14, the subject matter of Examples 12-13 includes, replacing the response with the second response includes determining that a user level of expertise classification for the user is lower than a second user level of expertise classification for the agent.

In Example 15, the subject matter of Examples 1-14 includes, retraining the GenAI model using the response and the user query.

Example 16 is at least one non-transitory machine-readable medium including instructions, which when executed by processing circuitry, cause the processing circuitry to perform operations to: receive, at an entity resolution service and during a conversation between a chatbot and a user logged into the entity resolution service on a chatbot service interface of the entity resolution service, a user query entered by the user; determine, using a generative artificial intelligence (GenAI) model, a context configured to be predictive of an intent of the user query; based on the context, generate, using the GenAI model, a contextual query configured to generate a response to the intent of the user query; obtain data responsive to the user query based on a search of an entity resolution data source using the contextual query; generate, using the GenAI model, a response to the intent of the user query based on the obtained data; and output the response to the chatbot service interface for display.

In Example 17, the subject matter of Example 16 includes, wherein to detect the context includes to identify an attribute value in the user query, the attribute value including at least one of a temporal reference, a geographical location, a sequence of events, a definition, a cause and effect, a textual pattern, a semantic relationship, or a situational context.

In Example 18, the subject matter of Examples 16-17 includes, wherein the instructions further cause the processing circuitry to perform operations to: collect feedback from the user at the chatbot service interface; and retrain the GenAI model using the collected feedback.

In Example 19, the subject matter of Examples 16-18 includes, wherein the response includes at least one of an action suggestion or a reply including requested information.

In Example 20, the subject matter of Examples 16-19 includes, wherein the entity resolution data source includes at least one of a third-party database, a local database, a cloud data storage, or a streaming data source.

In Example 21, the subject matter of Examples 16-20 includes, wherein the GenAI model is trained with chatbot service historical data.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include but are not limited to, hard disks, removable magnetic disks, removable optical disks (e.g., compact disks and digital video disks), magnetic cassettes, memory cards or sticks, random access memories (RAMs), read-only memories (ROMs), and the like.

What is claimed is:

1. A method comprising:
receiving, at an entity resolution service and during a conversation between a chatbot and a user logged into the entity resolution service on a chatbot service interface of the entity resolution service, a user query entered by the user;
determining, using a generative artificial intelligence (GenAI) model trained with chatbot service historical data, a context configured to be predictive of an intent of the user query;
based on the context, generating, using the GenAI model, a contextual query configured to generate a response to the intent of the user query;
obtaining data responsive to the user query based on a search of an entity resolution data source using the contextual query;
generating, using the GenAI model, a response to the intent of the user query based on the obtained data; and
outputting the response to the chatbot service interface for display.

2. The method of claim 1, wherein the user query includes at least one of a document, a form, a text message, a voice message, or a video message.

3. The method of claim 1, wherein determining the context includes identifying an attribute value in the user query, the attribute value including at least one of a temporal reference, a geographical location, a sequence of events, a definition, a cause and effect, a textual pattern, a semantic relationship, or a situational context.

4. The method of claim 1, wherein the contextual query includes data search instructions for generating a response to the user query.

5. The method of claim 1, further comprising:
collecting feedback from the user at the chatbot service interface; and
retraining the GenAI model using the collected feedback.

6. The method of claim 1, wherein the response includes at least one of an action suggestion, a reply including requested information, a flag suggesting further investigation, a report of all chatbot activity, an explanation, or a suggestion for an alternative approach.

7. The method of claim 1, wherein the entity resolution data source includes at least one of a third-party database, a local database, a cloud data storage, or a streaming data source.

8. The method of claim 1, wherein the user query is at least one of a voice message or a video message.

9. The method of claim 8, further comprising:
before determining the context of the user query, converting the user query to written text.

10. The method of claim 1, wherein the user has a user level of expertise classification and the response is further based on the user level of expertise classification of the user.

11. The method of claim 1, further comprising:
determining, using a machine learning model separate from the GenAI model, a reliability score for the response based on the user query; and
determining whether the reliability score is above a threshold;
wherein outputting the response to the chatbot service interface for display includes outputting the response to the chatbot service interface for display in response to determining that the reliability score is above a threshold.

12. The method of claim 1, further comprising:
determining, using using a machine learning model separate from the GenAI model, a reliability score for the response based on the user query;
determining whether the reliability score is below a threshold;
in response to the determining that the reliability score is below a threshold, forwarding the user query and the response to an agent;
receiving a second response from the agent; and
before outputting the response to the chatbot service interface for display, replacing the response with the second response.

13. The method of claim 12,
wherein the agent includes a plurality of individuals, each individual generating an agent response; and
further comprising:
determining, using the machine learning model separate from the GenAI model, a score for each agent response of each individual of the plurality of individuals, wherein the second response includes an agent response with a highest score.

14. The method of claim 12, replacing the response with the second response includes determining that a user level of expertise classification for the user is lower than a second user level of expertise classification for the agent.

15. The method of claim 1, further comprising:
retraining the GenAI model using the response and the user query.

16. At least one non-transitory machine-readable medium including instructions, which when executed by processing circuitry, cause the processing circuitry to perform operations to:
receive, at an entity resolution service and during a conversation between a chatbot and a user logged into the entity resolution service on a chatbot service interface of the entity resolution service, a user query entered by the user;
determine, using a generative artificial intelligence (GenAI) model, a context configured to be predictive of an intent of the user query;
based on the context, generate, using the GenAI model, a contextual query configured to generate a response to the intent of the user query;
obtain data responsive to the user query based on a search of an entity resolution data source using the contextual query;
generate, using the GenAI model, a response to the intent of the user query based on the obtained data; and
output the response to the chatbot service interface for display.

17. The at least one non-transitory machine-readable medium of claim 16, wherein to detect the context includes to identify an attribute value in the user query, the attribute value including at least one of a temporal reference, a geographical location, a sequence of events, a definition, a cause and effect, a textual pattern, a semantic relationship, or a situational context.

18. The at least one non-transitory machine-readable medium of claim 16, wherein the instructions further cause the processing circuitry to perform operations to:
collect feedback from the user at the chatbot service interface; and
retrain the GenAI model using the collected feedback.

19. The at least one non-transitory machine-readable medium of claim 16, wherein the response includes at least one of an action suggestion or a reply including requested information.

20. The at least one non-transitory machine-readable medium of claim 16, wherein the entity resolution data source includes at least one of a third-party database, a local database, a cloud data storage, or a streaming data source.
